(19) United States
(12) Patent Application Publication
(10) Pub. No.: US 2022/0284320 A1
(43) Pub. Date: Sep. 8, 2022

(54) USING MACHINE-LEARNED MODELS TO THROTTLE CONTENT

(71) Applicant: Microsoft Technology Licensing, LLC, Redmond, WA (US)

(72) Inventors: Jinyun YAN, San Jose, CA (US); Shaunak CHATTERJEE, Sunnyvale, CA (US); Runfang ZHOU, Sunnyvale, CA (US)

(21) Appl. No.: 17/190,399

(22) Filed: Mar. 3, 2021

(51) Int. Cl. G06N 5/04; G06F 16/248; G06N 20/00

(52) U.S. Cl. CPC G06N 5/04; G06F 16/248; G06N 20/00

(57) ABSTRACT

Techniques for using machine-learned models to throttle content are provided. In one technique, based on multiple selection events, a distribution of relevance measures is computed, where the relevance measures are associated with the content item selection events. The relevance measures may be generated by one or more machine-learned models. Based on the computed distribution, a threshold relevance measure is computed. Thereafter, a request for content is received over a computer network. In response, a computer system performs, in real-time, multiple steps. For example, an identity of an entity that is associated with the request is identified and, based on that identity, multiple content delivery groups are identified. A relevance measure of one of the content delivery groups relative to the entity is determined and compared to the threshold relevance measure. The content delivery group is selected only after determining that the relevance measure is above the threshold relevance measure.

### TECHNICAL FIELD

The present disclosure relates to machine learning and, more particularly, to throttling electronic content based on output from one or more machine-learned models.

### BACKGROUND

The Internet allows end-users operating computing devices to request content from many different content platforms. Some content platforms desire to send additional content items to users who visit their respective websites or who otherwise interact with the content platforms. To do so, content platforms may rely on third-party content providers to provide the additional content items so that users who visit the content platforms are presented with the additional content items.

Due to the large number of available additional content items from which to choose, each additional content item is typically allocated a certain number, or amount, of resources, such as a specific number of presentations or user actions. For example, an additional content item may be allocated twenty presentations in a day, after which the additional content item can no longer be selected for presentation on a remote computing device on that day. The act of removing an additional content item from being considered is referred to as content throttling. Content throttling may occur if the initially allocated resources of an additional content item have all been utilized or if the current resource utilization of the additional content item significantly exceeds a current pacing threshold for the additional content item, even though the allocated resources have not all been utilized. However, current content throttling techniques are inefficient in that they do not take into account machine-learned models in determining which additional content items to throttle.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

In the drawings:

FIG. 1 is a block diagram that depicts a system for distributing content items to one or more end-users, in an embodiment;

FIG. 2 is a flow diagram that depicts an example process for using one or more machine-learned models to throttle electronic content, in an embodiment;

FIGS. 3A-3B are charts of example distributions of relevance measures, in an embodiment;

FIG. 4 is a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

A system and method are provided to efficiently throttle content items based on output from machine-learned models. In one technique, one or more machine-learned models are leveraged to generate a user action prediction for a content delivery group in each of multiple past content item selection events. The user action predictions are organized to generate a distribution of user action predictions. Also, a prediction of resource utilization for the content delivery group is made. Based on this resource utilization prediction and the distribution of user action predictions, a threshold user action prediction is selected from the distribution and associated with that content delivery group. Thereafter, if the content delivery group participates in a content item selection event, then a user prediction action generated for that group relative to a current user associated with a content request is compared to the threshold user action prediction. If the former is less than the latter, then the content delivery group may be removed from the content item selection event.

In a related technique, the machine-learned model(s) generate relevance scores and the generated distribution is a distribution of relevance scores. The relevance scores are not required to be user action predictions, but may be correlated with them. For example, the higher the relevance score, the higher the user action prediction.

Embodiments improve real-time content selection technology by removing some content items from consideration in real-time, resulting in a decrease in the amount of data to process (and, therefore, time required) to select a content item in response to a content request. Embodiments also improve real-time content selection technology through an improved user experience because highly relevant content items have a greater chance (relative to lower relevant content items) to be selected in content item selection events. Furthermore, higher quality content delivery groups will achieve better results (e.g., presentations, user selections), resulting in higher ROI for content providers.

### System Overview

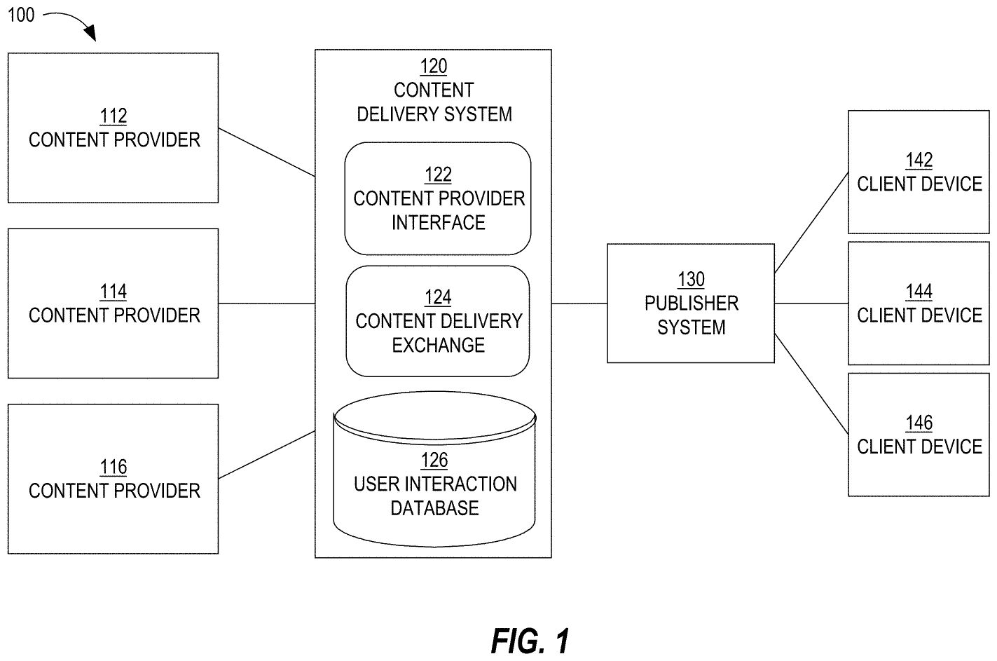

FIG. 1 is a block diagram that depicts a system 100 for distributing content items to one or more end-users, in an embodiment. System 100 includes content providers 112-116, a content delivery system 120, a publisher system 130, and client devices 142-146. Although three content providers are depicted, system 100 may include more or less content providers. Similarly, system 100 may include more than one publisher and more or less client devices.

Content providers 112-116 interact with content delivery system 120 (e.g., over a network, such as a LAN, WAN, or the Internet) to enable content items to be presented, through publisher system 130, to end-users operating client devices 142-146. Thus, content providers 112-116 provide content items to content delivery system 120, which in turn selects content items to provide to publisher system 130 for presentation to users of client devices 142-146. However, at the time that content provider 112 registers with content delivery system 120, neither party may know which end-users or client devices will receive content items from content provider 112.

An example of a content provider includes an advertiser. An advertiser of a product or service may be the same party as the party that makes or provides the product or service. Alternatively, an advertiser may contract with a producer or service provider to market or advertise a product or service provided by the producer/service provider. Another example of a content provider is an online ad network that contracts with multiple advertisers to provide content items (e.g., advertisements) to end users, either through publishers directly or indirectly through content delivery system 120.

Although depicted in a single element, content delivery system 120 may comprise multiple computing elements and devices, connected in a local network or distributed regionally or globally across many networks, such as the Internet. Thus, content delivery system 120 may comprise multiple computing elements, including file servers and database systems. For example, content delivery system 120 includes (1) a content provider interface 122 that allows content providers 112-116 to create and manage their respective content delivery groups and (2) a content delivery exchange 124 that conducts content item selection events in response to content requests from a third-party content delivery exchange and/or from publisher systems, such as publisher system 130.

Publisher system 130 provides its own content to client devices 142-146 in response to requests initiated by users of client devices 142-146. The content may be about any topic, such as news, sports, finance, and traveling. Publishers may vary greatly in size and influence, such as Fortune 500 companies, social network providers, and individual bloggers. A content request from a client device may be in the form of a HTTP request that includes a Uniform Resource Locator (URL) and may be issued from a web browser or a software application that is configured to only communicate with publisher system 130 (and/or its affiliates). A content request may be a request that is immediately preceded by user input (e.g., selecting a hyperlink on web page) or may be initiated as part of a subscription, such as through a Rich Site Summary (RSS) feed. In response to a request for content from a client device, publisher system 130 provides the requested content (e.g., a web page) to the client device.

Simultaneously or immediately before or after the requested content is sent to a client device, a content request is sent to content delivery system 120 (or, more specifically, to content delivery exchange 124). That request is sent (over a network, such as a LAN, WAN, or the Internet) by publisher system 130 or by the client device that requested the original content from publisher system 130. For example, a web page that the client device renders includes one or more calls (or HTTP requests) to content delivery exchange 124 for one or more content items. In response, content delivery exchange 124 provides (over a network, such as a LAN, WAN, or the Internet) one or more particular content items to the client device directly or through publisher system 130. In this way, the one or more particular content items may be presented (e.g., displayed) concurrently with the content requested by the client device from publisher system 130.

In response to receiving a content request, content delivery exchange 124 initiates a content item selection event that involves selecting one or more content items (from among multiple content items) to present to the client device that initiated the content request. An example of a content item selection event is an auction.

Content delivery system 120 and publisher system 130 may be owned and operated by the same entity or party. Alternatively, content delivery system 120 and publisher system 130 are owned and operated by different entities or parties.

A content item may comprise an image, a video, audio, text, graphics, virtual reality, or any combination thereof. A content item may also include a link (or URL) such that, when a user selects (e.g., with a finger on a touchscreen or with a cursor of a mouse device) the content item, a (e.g., HTTP) request is sent over a network (e.g., the Internet) to a destination indicated by the link. In response, content of a web page corresponding to the link may be displayed on the user's client device.

Examples of client devices 142-146 include desktop computers, laptop computers, tablet computers, wearable devices, video game consoles, and smartphones.

### Bidders

In a related embodiment, system 100 also includes one or more bidders (not depicted). A bidder is a party that is different than a content provider, that interacts with content delivery exchange 124, and that bids for space (on one or more publisher systems, such as publisher system 130) to present content items on behalf of multiple content providers. Thus, a bidder is another source of content items that content delivery exchange 124 may select for presentation through publisher system 130. Thus, a bidder acts as a content provider to content delivery exchange 124 or publisher system 130. Examples of bidders include AppNexus, DoubleClick, and LinkedIn. Because bidders act on behalf of content providers (e.g., advertisers), bidders create content delivery groups and, thus, specify user targeting criteria and, optionally, frequency cap rules, similar to a traditional content provider.

In a related embodiment, system 100 includes one or more bidders but no content providers. However, embodiments described herein are applicable to any of the above-described system arrangements.

### Content Delivery Groups

Each content provider establishes a content delivery group with content delivery system 120 through, for example, content provider interface 122. An example of content provider interface 122 is Campaign Manager™ provided by LinkedIn. Content provider interface 122 comprises a set of user interfaces that allow a representative of a content provider to create an account for the content provider, create one or more content delivery groups within the account, and establish one or more attributes of each content delivery group. Examples of group attributes are described in detail below.

A content delivery group includes (or is associated with) one or more content items. Thus, the same content item may be presented to users of client devices 142-146. Alternatively, a content delivery group may be designed such that the same user is (or different users are) presented different content items from the same group. For example, the content items of a content delivery group may have a specific order, such that one content item is not presented to a user before another content item is presented to that user.

A content delivery group (also referred to as a “content delivery campaign”) is an organized way to present information to users that qualify for the group. Different content providers have different purposes in establishing a content delivery group. Example purposes include having users view a particular video or web page, fill out a form with personal information, purchase a product or service, make a donation to a charitable organization, volunteer time at an organization, or become aware of an enterprise or initiative, whether commercial, charitable, or political.

A content delivery group has a start date/time and, optionally, a defined end date/time. For example, a content delivery group may be to present a set of content items from Jun. 1, 2015 to Aug. 1, 2015, regardless of the number of times the set of content items are presented (“impressions”), the number of user selections of the content items (e.g., click throughs), or the number of conversions that resulted from the content delivery group. Thus, in this example, there is a definite (or “hard”) end date. As another example, a content delivery group may have a “soft” end date, where the content delivery group ends when the corresponding set of content items are displayed a certain number of times, when a certain number of users view, select, or click on the set of content items, when a certain number of users purchase a product/service associated with the content delivery group or fill out a particular form on a web site, or when a budget of the content delivery group has been exhausted.

A content delivery group may specify one or more targeting criteria that are used to determine whether to present a content item of the content delivery group to one or more users. (In most content delivery systems, targeting criteria cannot be so granular as to target individual members.) Example factors include date of presentation, time of day of presentation, characteristics of a user to which the content item will be presented, attributes of a computing device that will present the content item, identity of the publisher, etc. Examples of characteristics of a user include demographic information, geographic information (e.g., of an employer), job title, employment status, academic degrees earned, academic institutions attended, former employers, current employer, number of connections in a social network, number and type of skills, number of endorsements, and stated interests. Examples of attributes of a computing device include type of device (e.g., smartphone, tablet, desktop, laptop), geographical location, operating system type and version, size of screen, etc.

For example, targeting criteria of a particular content delivery group may indicate that a content item is to be presented to users with at least one undergraduate degree, who are unemployed, who are accessing from South America, and where the request for content items is initiated by a smartphone of the user. If content delivery exchange 124 receives, from a computing device, a request that does not satisfy the targeting criteria, then content delivery exchange 124 ensures that any content items associated with the particular content delivery group are not sent to the computing device.

Thus, content delivery exchange 124 is responsible for selecting a content delivery group in response to a request from a remote computing device by comparing (1) targeting data associated with the computing device and/or a user of the computing device with (2) targeting criteria of one or more content delivery groups. Multiple content delivery groups may be identified in response to the request as being relevant to the user of the computing device. Content delivery exchange 124 may select a strict subset of the identified content delivery groups from which content items will be identified and presented to the user of the computing device.

Instead of one set of targeting criteria, a single content delivery group may be associated with multiple sets of targeting criteria. For example, one set of targeting criteria may be used during one period of time of the content delivery group and another set of targeting criteria may be used during another period of time of the group. As another example, a content delivery group may be associated with multiple content items, one of which may be associated with one set of targeting criteria and another one of which is associated with a different set of targeting criteria. Thus, while one content request from publisher system 130 may not satisfy targeting criteria of one content item of a group, the same content request may satisfy targeting criteria of another content item of the group.

Different content delivery groups that content delivery system 120 manages may have different charge models. For example, content delivery system 120 (or, rather, the entity that operates content delivery system 120) may charge a content provider of one content delivery group for each presentation of a content item from the content delivery group (referred to herein as cost per impression or CPM). Content delivery system 120 may charge a content provider of another content delivery group for each time a user interacts with a content item from the content delivery group, such as selecting or clicking on the content item (referred to herein as cost per click or CPC). Content delivery system 120 may charge a content provider of another content delivery group for each time a user performs a particular action, such as purchasing a product or service, downloading a software application, or filling out a form (referred to herein as cost per action or CPA). Content delivery system 120 may manage only groups that are of the same type of charging model or may manage groups that are of any combination of the three types of charging models.

A content delivery group may be associated with a resource budget that indicates how much the corresponding content provider is willing to be charged by content delivery system 120, such as $100 or $5,200. A content delivery group may also be associated with a bid amount that indicates how much the corresponding content provider is willing to be charged for each impression, click, or other action. For example, a CPM group may bid five cents for an impression, a CPC group may bid five dollars for a click, and a CPA group may bid five hundred dollars for a conversion (e.g., a purchase of a product or service).

### Content Item Selection Events

As mentioned previously, a content item selection event is when multiple content items (e.g., from different content delivery groups) are considered and a subset selected for presentation on a computing device in response to a request. Thus, each content request that content delivery exchange 124 receives triggers a content item selection event.

For example, in response to receiving a content request, content delivery exchange 124 analyzes multiple content delivery groups to determine whether attributes associated with the content request (e.g., attributes of a user that initiated the content request, attributes of a computing device operated by the user, current date/time) satisfy targeting criteria associated with each of the analyzed content delivery groups. If so, the content delivery group is considered a candidate content delivery group. One or more filtering criteria may be applied to a set of candidate content delivery groups to reduce the total number of candidates.

As another example, users are assigned to content delivery groups (or specific content items within groups) “off-line”; that is, before content delivery exchange 124 receives a content request that is initiated by the user. For example, when a content delivery group is created based on input from a content provider, one or more computing components may compare the targeting criteria of the content delivery group with attributes of many users to determine which users are to be targeted by the content delivery group. If a user's attributes satisfy the targeting criteria of the content delivery group, then the user is assigned to a target audience of the content delivery group. Thus, an association between the user and the content delivery group is made. Later, when a content request that is initiated by the user is received, all the content delivery groups that are associated with the user may be quickly identified, in order to avoid real-time (or on-the-fly) processing of the targeting criteria. Some of the identified groups may be further filtered based on, for example, the group being deactivated or terminated, the device that the user is operating being of a different type (e.g., desktop) than the type of device targeted by the group (e.g., mobile device).

A final set of candidate content delivery groups is ranked based on one or more criteria, such as predicted click-through rate (which may be relevant only for CPC groups), effective cost per impression (which may be relevant to CPC, CPM, and CPA groups), and/or bid price. Each content delivery group may be associated with a bid price that represents how much the corresponding content provider is willing to pay (e.g., content delivery system 120) for having a content item of the group presented to an end-user or selected by an end-user. Different content delivery groups may have different bid prices. Generally, content delivery groups associated with relatively higher bid prices will be selected for displaying their respective content items relative to content items of content delivery groups associated with relatively lower bid prices. Other factors may limit the effect of bid prices, such as objective measures of quality of the content items (e.g., actual click-through rate (CTR) and/or predicted CTR of each content item), budget pacing (which controls how fast a group's budget is used and, thus, may limit a content item from being displayed at certain times), frequency capping (which limits how often a content item is presented to the same person), and a domain of a URL that a content item might include.

An example of a content item selection event is an advertisement auction, or simply an “ad auction.”

In one embodiment, content delivery exchange 124 conducts one or more content item selection events. Thus, content delivery exchange 124 has access to all data associated with making a decision of which content item(s) to select, including bid price of each group in the final set of content delivery groups, an identity of an end-user to which the selected content item(s) will be presented, an indication of whether a content item from each group was presented to the end-user, a predicted CTR of each group, a CPC or CPM of each group.

In another embodiment, an exchange that is owned and operated by an entity that is different than the entity that operates content delivery system 120 conducts one or more content item selection events. In this latter embodiment, content delivery system 120 sends one or more content items to the other exchange, which selects one or more content items from among multiple content items that the other exchange receives from multiple sources. In this embodiment, content delivery exchange 124 does not necessarily know (a) which content item was selected if the selected content item was from a different source than content delivery system 120 or (b) the bid prices of each content item that was part of the content item selection event. Thus, the other exchange may provide, to content delivery system 120, information regarding one or more bid prices and, optionally, other information associated with the content item(s) that was/were selected during a content item selection event, information such as the minimum winning bid or the highest bid of the content item that was not selected during the content item selection event.

### Event Logging

Content delivery system 120 may log one or more types of events, with respect to content items, across client devices 142-146 (and other client devices not depicted). For example, content delivery system 120 determines whether a content item that content delivery exchange 124 delivers is presented at (e.g., displayed by or played back at) a client device. Such an “event” is referred to as an “impression.” As another example, content delivery system 120 determines whether a user interacted with a content item that exchange 124 delivered to a client device of the user. Examples of “user interaction” include a view or a selection, such as a “click.” Content delivery system 120 stores such data as user interaction data, such as an impression data set and/or a interaction data set. Thus, content delivery system 120 may include a user interaction database 126. Logging such events allows content delivery system 120 to track how well different content items and/or groups perform.

For example, content delivery system 120 receives impression data items, each of which is associated with a different instance of an impression and a particular content item. An impression data item may indicate a particular content item, a date of the impression, a time of the impression, a particular publisher or source (e.g., onsite v. offsite), a particular client device that displayed the specific content item (e.g., through a client device identifier), and/or a user identifier of a user that operates the particular client device. Thus, if content delivery system 120 manages delivery of multiple content items, then different impression data items may be associated with different content items. One or more of these individual data items may be encrypted to protect privacy of the end-user.

Similarly, an interaction data item may indicate a particular content item, a date of the user interaction, a time of the user interaction, a particular publisher or source (e.g., onsite v. offsite), a particular client device that displayed the specific content item, and/or a user identifier of a user that operates the particular client device. If impression data items are generated and processed properly, an interaction data item should be associated with an impression data item that corresponds to the interaction data item. From interaction data items and impression data items associated with a content item, content delivery system 120 may calculate an observed (or actual) user interaction rate (e.g., CTR) for the content item. Also, from interaction data items and impression data items associated with a content delivery group (or multiple content items from the same content delivery group), content delivery system 120 may calculate a user interaction rate for the content delivery group. Additionally, from interaction data items and impression data items associated with a content provider (or content items from different content delivery groups initiated by the content item), content delivery system 120 may calculate a user interaction rate for the content provider. Similarly, from interaction data items and impression data items associated with a class or segment of users (or users that satisfy certain criteria, such as users that have a particular job title), content delivery system 120 may calculate a user interaction rate for the class or segment. In fact, a user interaction rate may be calculated along a combination of one or more different user and/or content item attributes or dimensions, such as geography, job title, skills, content provider, certain keywords in content items, etc.

### Resource Limit

In an embodiment, a content delivery group is associated with a resource limit or “allocation.” The resource limit may be a default value, a value specified by the content provider of the content delivery group, or a value specified by a representative of content delivery system 120. The resource limit dictates whether a content item associated with the content delivery group is a candidate for transmission in response to a content request. For example, if actual resource usage/utilization of the content delivery group is equal to or greater than the resource limit, then the content delivery group (or its associated content item(s)) is not a candidate when processing a content request.

Example resources include computing resources (e.g., CPU, memory, network I/O, and storage I/O) and monetary resources. If the latter, then the monetary resources represent an amount that a content provider is willing to spend on the corresponding content delivery group. Content delivery system 120 may receive a portion of the monetary resources, but must ensure that those monetary resources are not exceeded; else, content delivery system 120 is forfeiting either actual or potential compensation if content delivery system 120 continues to respond to content requests with content items from the content delivery group whose associated or allocated resources have been depleted or used up.

At least for content delivery groups that have a resource limit, content delivery system 120 maintains a current resource usage of each group. For example, the resource limit of a particular content delivery group may be 80 units and a current resource usage of the group is 65 units. For each content delivery group (or at least for ones that are deemed important), content delivery exchange 124 updates (e.g., in real-time or in near real-time) the current resource usage of the group based on user interaction data items (e.g., impression data items and/or click data items) that content delivery system 120 receives and that pertain to the group.

### Content Throttling

Content throttling involves removing one or more content delivery groups from a content item selection event due to resource utilization and/or pacing requirements, even though the user associated with a content request satisfies the targeting criteria of those groups. For example, all the resources allocated to a content delivery group may have been utilized by content delivery system 120. Therefore, content delivery system 120 stores, in association with the content delivery group, resource depletion data that indicates that the content delivery group should not be selected until additional resources are allocated to the content delivery group, which may automatically happen at the conclusion of the day or other pre-defined time period.

As another example, a resource utilization curve may be calculated that ensures that all the resources of a content delivery group are not utilized right away (e.g., at the beginning of the day), but rather the utilization is smoothed out throughout a time period (e.g., a day). (Different groups may be associated with different resource utilization curves or may be associated with the same utilization curve.) Therefore, if the current resource utilization of a content delivery group is greater than a planned-for resource utilization (according to a resource utilization curve) at a certain point in the time period, then the content delivery group may be removed from the corresponding content item selection event or may be subject to a throttling step.

A throttling step refers to either removing a content delivery group from consideration during a content item selection event or first “rolling the dice” to determine whether the content delivery group is to be removed from consideration. Such “rolling the dice” involves generating a random (or pseudo random) number and determining whether the number (or a value derived therefrom) is less/greater than a certain threshold. For example, a modulo operation is performed on a random number and it is determined whether the result of the modulo operation is less than 25 (out of 100). If so, then the content delivery group is removed from consideration, indicating that (at least for this group at this time) there is a 75% chance of not being throttled. The threshold may change throughout the day and may change based on current resource utilization of the content delivery group.

### Relevance Measures

In prior techniques for content throttling, only resource allocation considerations were used to determine whether to throttle a content delivery group. In an embodiment, relevance measures are used to determine whether to throttle a content delivery group. A relevance measure is one or more values that indicate a relevance of a content item (or the content delivery group from which the content item originates) to an entity (or user). Thus, the relevance measure between a content item and a first entity may be very different than the relevance measure between the content item and a second entity. Similarly, the relevance measure between a first content item and an entity may be very different than the relevance measure between a second content item and the entity.

A relevance measure may be generated for a content item-entity pair in response to receiving a content request that was initiated by the entity where multiple content delivery groups are identified that includes a group to which the content item belongs.

An example of a relevance measure is a number of similarities between a content delivery group and an entity. Another example of a relevance measure is a user action prediction that reflects a probability that a user (or entity) will perform a particular action in response to being presented with the content item. Example actions include selecting (or clicking on) a particular content item, watching a certain amount (e.g., 3 seconds) of a video of a particular content item, visiting a particular website after clicking on a particular content item, filling out a particular form, registering for a particular event, and purchasing a particular product or class of products. Relevance measures may be generated using one or more rule-based models and/or one or more machine-learned models, each of which are described in more details herein.

### Rule-Based Model

Generating a relevance measure for an entity-content item pair may be performed in a number of ways. For example, rules may be established that identify certain entity attributes, identify certain content item attributes (e.g., observed user selection rate; industry of content provider), count certain activities of an entity, and/or compare entity attributes with content item attributes. Each entity attribute, each content item attribute, each count, and each entity-content item attribute match may correspond to a different score and, based on a combination of all the scores, determine a relevance measure for the entity. For example, a user “following” a company online may result in three points, the user establishing one or more connections with employees at one or more companies in a particular region may be result in five points (bringing the total to eight points), the user sending multiple messages to those employees may result in ten points (bringing the total to eighteen points), and the user and a content item being associated with the same industry may result in five points (bringing the total to 23 points). If a user-content item pair reaches twenty points, then there is a non-insignificant probability that the user will select the content item is the content item is presented on a computing device of the user.

Rules may be determined manually by analyzing characteristics of content items and users who have selected content items in the past. For example, it may be determined that 56% of users who made a new connection to an employee of an organization, sent multiple messages to the new connection, and applied to multiple job positions associated with a region associated with the organization ultimately selected a content item associated with the organization.

A rule-based model has numerous disadvantages. One disadvantage is that it fails to capture nonlinear correlations. For example, if a user clicks on (or otherwise selects) a significant number of content items, then the model may compute a high score, since the user accumulates, for example, five points for each click on a content item. However, there may be diminishing returns for each click after a certain number. The most likely users to perform a target action (e.g., a sign up or a purchase) may perform, for example, between five and eight clicks within a week period. Clicking on more than eight content items may not indicate a significant probability of the target action. In fact, it may even be the case that clicking on many content items is a negative signal for the target action. For example, such behavior could indicate a fraudulent entity. In addition, complex interactions of features cannot be represented by such rule-based models.

Another issue with a rule-based prediction model is that the hand-selection of values (e.g., weights or coefficients) for each feature is error-prone, time consuming, and non-probabilistic. Hand-selection also allows for bias from potentially mistaken business logic.

A third disadvantage is that output of a rule-based model is an unbounded positive or negative value. The output of a rule-based model does not intuitively map to the probability of a click, conversion, or other type of action for which the model is optimizing (e.g., predicting). In contrast, machine learning methods are probabilistic and therefore can give intuitive probability scores.

### Machine-Learned Model

In an embodiment, instead of relying on hand-curated rules to generate a relevance measure for an entity-content item pair, one or more machine-learned models are leveraged to do so. A machine-learned model is a model that is generated based on training data using one or more machine learning techniques. Machine learning is the study and construction of algorithms that can learn from, and make predictions on, data. Such algorithms operate by building a model from inputs in order to make data-driven predictions or decisions. Thus, a machine learning technique is used to generate a statistical model that is trained based on a history of attribute values associated with entities (users) and content items. The statistical model is trained based on multiple attributes (or factors) described herein. In machine learning parlance, such attributes are referred to as “features.” To generate and train a statistical model, a set of features is specified and a set of training data is identified.

Embodiments are not limited to any particular machine learning technique for generating or training a model. Example machine learning techniques include linear regression, logistic regression, random forests, naive Bayes, and Support Vector Machines (SVMs). Advantages that machine-learned models have over rule-based models include the ability of machine-learned models to output a probability (as opposed to a number that might not be translatable to a probability), the ability of machine-learned models to capture non-linear correlations between features, and the reduction in bias in determining weights for different features.

A machine-learned model may output different types of data or values, depending on the input features and the training data. For example, training data may comprise, for each entity, multiple feature values, each corresponding to a different feature. Example features include the features that are based on entity attributes, based on content item attributes, and/or based on a cross between entity attributes and content item attributes, such as whether a particular attribute value of an entity matches a particular attribute value of a content item. In order to generate the training data, information about each entity-content item pair (or entity-content delivery group pair) is analyzed to compute the different feature values. In this example, the label (or dependent variable) of each training instance may be whether the entity performed a particular action after being presented with a content item from the content delivery group.

Initially, the number of features that are considered for training may be significant. After training a machine-learned model and validating the model, it may be determined that a subset of the features have little correlation or impact on the final output. In other words, such features have low predictive power. Thus, machine-learned weights for such features may be relatively small, such as 0.01 or −0.001. In contrast, weights of features that have significant predictive power may have an absolute value of 0.2 or higher. Features will little predictive power may be removed from the training data. Removing such features can speed up the process of training future models and computing output scores, such as relevance measures.

### Process Overview

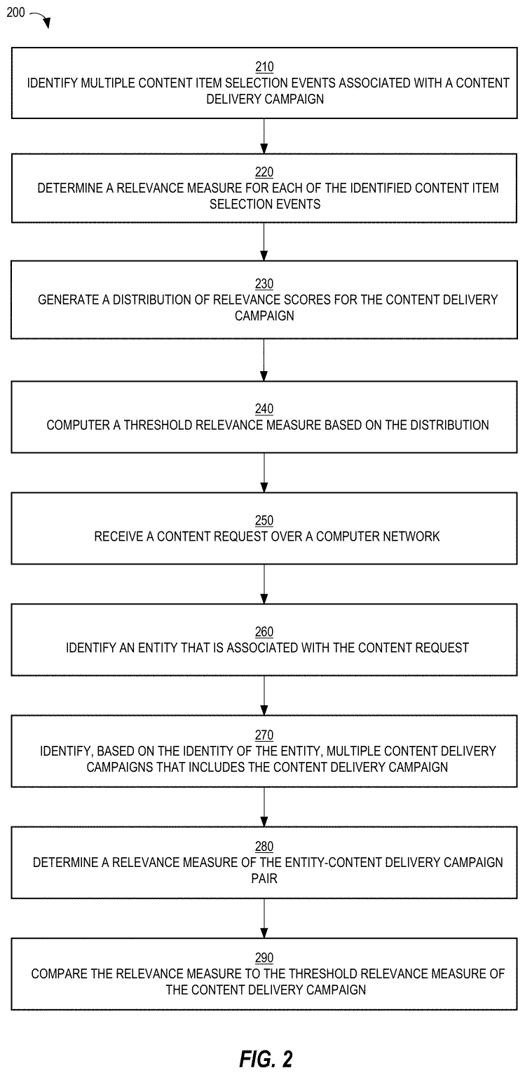

FIG. 2 is a flow diagram that depicts an example process 200 for using one or more machine-learned models to throttle electronic content, in an embodiment. Process 200 may be performed by content delivery system 120.

At block 210, multiple content item selection events are identified. These content item selection events may be limited to ones for which a particular content delivery group was a candidate. Alternatively, if the pertinent content delivery group has not yet begun, then these content item selection events may be limited to ones that were triggered by entities that are targeted by (or satisfy the targeting criteria of) a particular content delivery group.

The content item selection events may be limited to certain periods of time, such as individual days of the week or on weekends.

At block 220, for each of the identified content item selection events, a relevance measure is determined. The relevance measure reflects a measure of relevance of the particular content delivery group (or content item thereof) to the entity that triggered the content item selection event. A relevance measure may have been generated using a rule-based model or a machine-learned model. At the time of the content item selection event, the relevance measure may have been calculated and used to determine whether the corresponding content item was going to be selected.

At block 230, a distribution of relevance scores for the content delivery group is generated. Generating the distribution of relevance scores involves ordering the relevance measures based on their respective magnitudes. For example, the relevance scores may be ordered from largest to smallest or from smallest to largest.

At block 240, a threshold relevance measure is computed based on the distribution and one or more other factors, such as a resource allocation of the content delivery group, a resource utilization of the content delivery group, and/or a previous throttle rate of the content delivery group. For example, a resource reduction amount (e.g., bid) (or the winning amount of the corresponding content item selection event) is aggregated one at a time for each relevance measure in the distribution starting with the highest relevance measure until the total exceeds the resource allocation of the content delivery group. The threshold relevance measure that would cause the sum to exceed the resource allocation may be selected as the threshold relevance measure.

Blocks 210-240 may be performed for each of multiple content delivery groups. Thus, each iteration of blocks 210-240 may be performed in parallel with each other iteration of blocks 210-240.

At block 250, a content request is received over a computer network. For example, client device 142 transmits a content request over network 120 to publisher system 130. In response, publisher system 130 sends a content request to content delivery system 120. The content request includes an entity identifier.

At block 260, an identity of an entity that is associated with (or initiated) the content request is identified. Block 260 may involve retrieving an entity identifier that is included in the content request. Alternatively, block 260 may involve using another identifier (e.g., a browser cookie identifier, an IP address, or a MAC address) in the content request to lookup a mapping that associates the identifier with a corresponding entity identifier.

At block 270, based on the identity of the entity, multiple content delivery groups that includes the content delivery group are identified. Block 270 may involve identifying group identifiers that have previously been associated with the entity (e.g., offline). Alternatively, block 270 may involve retrieving attribute values (e.g., static and/or dynamic/behavioral) of the entity and identifying targeting criteria that are fully satisfied by those attribute values.

At block 280, a relevance measure of content delivery group is determined. Block 280 may involve using a machine-learned model to generate a predicted user selection rate. The model takes into account features of the entity, features of the group, and/or features of both the entity and the group. Block 280 may also involve determining a relevance measure for each group (relative to the entity) identified in block 270.

At block 290, the relevance measure is compared to a threshold relevance measure. For example, if the relevance measure is less than the threshold relevance measure, then the content delivery group is removed from consideration and is no longer selectable during this content item selection event. Otherwise, if the relevance measure is greater than the threshold relevance measure, then the content delivery group is not removed from consideration.

If multiple content delivery groups identified in block 270 are associated with respective threshold relevance measures, then block 290 may involve multiple comparisons, one for each content delivery group or relevance measure-threshold relevance measure pair. For example, groups C1, C2, and C3 are groups identified in block 270. Threshold relevance measures have been calculated for those groups, respectively: T1, T2, and T3. Also, relevance measures have been calculated for those groups, respectively, in block 280: R1, R2, and R3. Therefore, block 290 would involve comparing R1 to T1, R2 to T2, and R3 to T3.

Blocks 260-290 may be performed in real-time relative to block 250. For example, blocks 260-290 and any subsequent selection of a content item from one of the identified content delivery groups may be performed within one second or a few hundred milliseconds from receipt of the content request in block 250.

### Distribution of Relevance Measures

For a content delivery group that has a history of participating in content item selection events, a distribution of relevance measures may be computed based on the relevance measures of that content delivery group in those content item selection events. The distribution may be based on all content item selection events in which the group participated, not just the events that the group won or would have won. The past content item selection events are reflected in tracking events that indicate which content item selection events included the content delivery group. Each tracking event includes one or more group identifiers and may include a relevance measure or an event identifier that uniquely identifies that content item selection event relative to others and is used to retrieve the relevance measure of that group.

The relevance measures that are collected from past content item selection events are ordered based on magnitude. For example, the relevance measures may be ordered from smallest to largest or largest to smallest. The distribution may be fine-grained in that every relevance score is represented individually in the distribution. Alternatively, the distribution may be coarse-grained such that a possible range of relevance measures is divided up into smaller ranges and each relevance measure is assigned to the range that includes that relevance measure. For example, if the possible range of a relevance measure is 0 and 1, then the smaller ranges could each be 0.05; therefore, one range would be [0, 0.05), another range would be [0.05, 0.1), and so forth.

In an embodiment, the set of past content item selection events in which the subject content delivery group participated is limited, such as by time. For example, only the last 14 days of content item selection events are considered.

In a related embodiment, relevance measures of past content item selection events are weighted based on time. For example, the relevance measures of the subject group in more recent content item selection events are weighted higher than the relevance measures of the subject group in older content item selection events.

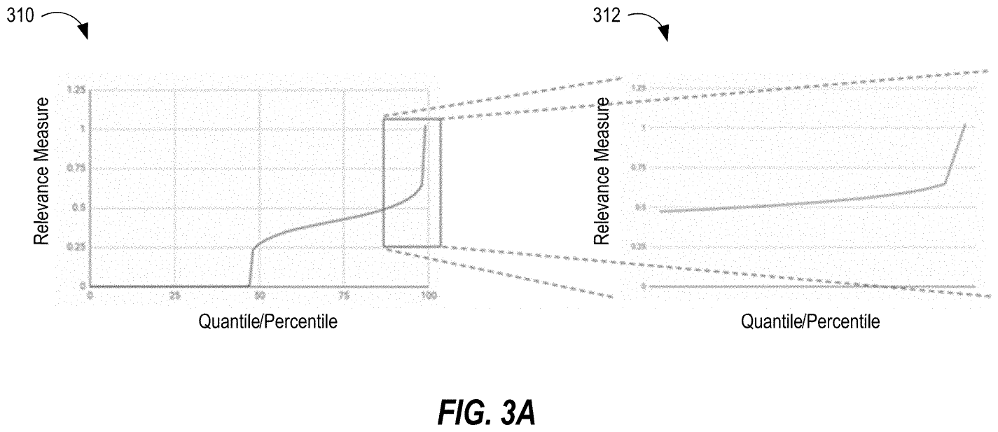

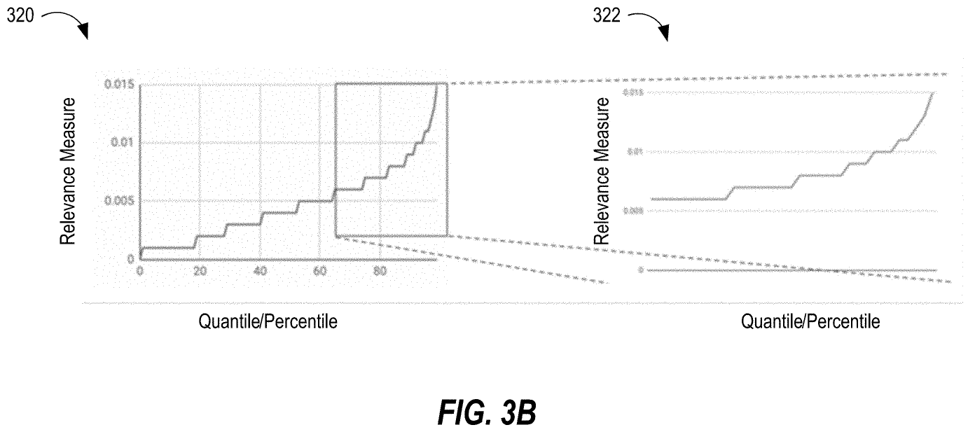

FIGS. 3A-3B are charts 310-322 of example distributions, respectively, in an embodiment. The x-axis on each chart is a percentile/quantile of the relevance measure (compared to all relevance measures of the group in the past content item selection events that make up the respective distributions) and the y-axis on each chart is relevance measure. Thus, the higher the relevance measure, the higher the percentile. Chart 312 reflects a subset of the data in chart 310. Similarly, chart 322 reflects a subset of the data in chart 320 after a threshold relevance measure is determined. For example, if the content item selection events corresponding to chart 310 were to be performed again given a threshold relevance measure at around 0.48, the corresponding group would have been selected only for the relevance measures reflected in chart 312. As another example, if the content item selection events corresponding to chart 320 were to be performed again given a threshold relevance measure at around 0.006, then the corresponding group would have been selected only for the relevance measures reflected in chart 322.

Each distribution is only a particular time period, such as a day. The particular time period depends on when resource allocations are reset. For example, the resource allocation of a content delivery group may be reset automatically at the end of each day, regardless of any remaining resources available to the group at the end of the day.

A threshold relevance measure (TRM) may be computed based on one or more criteria. For example, a TRM for a content delivery group is calculated according to the following steps: (1) select a relevance measure starting from the highest in a set of relevance measures (e.g., corresponding to content item selection events that occurred in a particular time period); (2) add an event resource reduction amount to a total that begins at zero prior to the first iteration of the first step; (3) determine whether the total exceeds the resource allocation of the content delivery group; (4a) if not, then return to step (1) where the next highest relevance measure is selected; (4b) if so, then identify the latest relevance measure as the threshold relevance measure.

The event resource reduction amount may be the resource reduction amount (e.g., bid) that is associated with the content delivery group or may be a related value. In the case that the event resource reduction amount is the resource reduction amount, then that amount may be fixed. In embodiments where the resource reduction amount is dynamic rather than fixed (meaning that the resource reduction amount may vary from one content item selection event to another), then computing the TRM may involve calculating a mean or median resource reduction amount and using that calculated value in step (2) above.

Alternatively, the event resource reduction amount is content item selection event-specific and may refer to the fact that content delivery exchange 124 conducts “second price” auctions or “second price” content item selection events, which involves charging a content provider (of the group that wins the content item selection event) an amount that is equal to the resource reduction amount of the content delivery group that was ranked just below the winning content delivery group. Otherwise, the content item selection event may be considered a first price event where a content provider is charged the resource reduction amount of its winning group.

Another technique for computing a TRM for a content delivery group that has content item selection event history is to determine a throttling rate of the content delivery group during the period of time reflected in the distribution. That throttling rate is then used to identify a quantile/percentile in the distribution, where the relevance measure at that point in the distribution becomes the TRM or is used to compute the TRM. In the example of FIG. 3B, the throttling rate of the subject group was 0.65 (or 65%, meaning that the group was throttled 65% of the time when it would have entered those content item selection events). Therefore, the relevance measure at the 65 percentile may be used as the TRM for the group.

As another example, a group has a daily budget of one thousand units and has been throttled in 50% of content item selection events using a prior throttling technique. In other words, the group can utilize one thousand units by entering half of the content item selection events at random. The TRM of the group may be chosen to be either at 50% (or at 40% if an extra buffer is desired) of the (e.g., pCTR) distribution so that the group can enter the best 50% (or 60%) of opportunities, which should be sufficient to utilize the daily budget. Sometimes, the TRM computed in this manner may be unnecessarily low; for example, the group may only need to enter its top 20% opportunities to utilize its budget. A prior throttling technique may be performed in order to bridge the gap between the low and optimal threshold. This is still an improvement over prior throttling techniques (that only relied on resource utilization) since the “threshold” of those prior throttling techniques is effectively zero.

In an embodiment, a TRM for a content delivery group is not computed if the resource utilization of the content delivery group is less than a certain percentage, such as 80%. For such groups, an existing throttling technique may be used, such as one that calculates a difference between a current resource utilization and a projected resource utilization for that point in time and if the current is (e.g., significantly) higher than the projected, then the group is throttled.

In an embodiment, a TRM for a content delivery group is computed for each of different time periods and the various TRMs are combined to generate an aggregated TRM, such as a mean or median TRM. For example, a TRM may be computed for each day of the last seven days and an average is computed from the seven TRMs. This average may then be used when determining whether to throttle the corresponding group from a content item selection event.

### Buffer

In an embodiment, a buffer is computed for a computed TRM. The buffer reflects how confident the system is that adhering to the TRM will not cause too much throttling or too little throttling. The less confident, the higher the buffer; the more confident, the lower the buffer. “Confidence” may be a measure of how much relevance measure data exists for a content delivery group and/or how much variance there is in the day. For example, seven days' worth of the relevance measure data for a content delivery group may be correlated with higher confidence, meaning that the buffer may be relatively low, such as 5%; meaning the final TRM for the group is 95% of the average TRM computed for the group. As another example, if four computed TRMs for a group are very different (e.g., the highest TRM is 2× the lowest), then the buffer may be relatively high, such as 25%, meaning the final TRM for the group is 75% of the median TRM computed for the group. Generally, the more relevance measure data there is, the higher confidence (or less variance) in the different computed (e.g., daily) TRMs. However, it is possible that a group has high variance in its computed TRMs even though there is a relatively large amount of relevance measure data.

### Multiple Threshold Relevance Measures for a Group

In an embodiment, a content delivery group is associated with multiple threshold relevance measures: one for different time periods. For example, a first threshold relevance measure (TRM) for a content delivery group is computed for Mondays, a second TRM is calculated for the middle of the week, a third TRM is calculated for Fridays, and a fourth TRM is calculated for the weekend. Then, depending on the day of the week in which a content request is received and the content delivery group is identified in response thereto, that day of the week is used to identify the appropriate TMR and apply it to determine whether to throttle the content delivery group. Each of these different TRMs may be computed based on multiple time period's (e.g., day's) worth of data, where the different TRMs are average or median values. For example, the Monday TRM is calculated based on relevance measure data from three previous Mondays, the mid-week TRM is calculated based on relevance measure data from six previous mid-week days, the Friday TRM is calculated based on relevance measure data from two previous Fridays, and so forth. In this example, the different TRMs may be associated with different buffers.

### Group with Insufficient Event History

In an embodiment, for a content delivery group that has not yet begun or has very little relevance measure data, a TRM is computed based on a target audience of the content delivery group. A target audience is identified based on identifying entities that satisfy the targeting criteria of the content delivery group. Then, their respective content item selection event history is retrieved and a relevance measure is computed for each entity-group pair. One or more distributions of relevance measures are computed for the content delivery group based on the identified content item selection events (or the ones that the group was eligible to enter) that target audience members initiated.

### Vary Throttling Rate Based on Relevance Measure

In an embodiment, even though a relevance measure computed for an entity-group pair (in a content item selection event) is below the corresponding group's TRM, it is still possible for that group to participate in the content item selection event. Thus, the TRM does not necessarily acts as an absolute filter of the group. Instead, a difference between the relevance measure and the TRM is used to determine whether the group may still be throttled. The greater the difference, the more likely the group will be removed from consideration in this content item selection event. Conversely, the lower the difference, the less likely the group will be removed from consideration in this content item selection event.

For example, a throttling rate is computed if the relevance measure is less than the corresponding TRM. The throttling rate may be computed using a linear function or a non-linear decreasing function. An example linear function is η*relevance measure/TRM, where η is a pre-defined constant. An example non-linear function is η*exp(−β(relevance measure/TRM)).

### Online Controller

A computed TRM for a content delivery group is based on historical content item selection event data; however, each resource utilization period (e.g., day) (1) the number and type of users and (2) the number of competing content delivery groups (i.e., that target some of the same users as the subject content delivery group) can be different from the users and competing groups reflected in the historical data. Therefore, in an embodiment, content delivery system 120 includes an online controller to adaptively adjust the TRM of a group to compensate for the discrepancy in offline estimation and online data. The high level intuition is that if the resource utilization is too low, then the online controller decreases or relaxes the TRM, while if the resource utilization is too high or fast, then the online controller increases or tightens the TRM.

In other words, the online controller controls the throttling of a content delivery group even if a relevance measure of an entity-group pair is above a TRM of the group. The online controller ensures that resource utilization of the group does not exceed the resource allocation of the group, at least above a certain amount, such as 20% above resource allocation. The online controller adjusts the TRM of the group during a resource utilization time period (e.g., a day) based on one or more factors. The adjustment may be positive or negative. Example factors include a current resource utilization of the group, a projected or hoped for resource utilization of the group, a current TRM, a past TRM during the same resource utilization time period, a time of the last TRM change, a time remaining in the resource utilization time period.

For example, in adjusting the TRM of a group, the online controller determines a current resource utilization of the group and determines a forecasted resource allocation of the group. The former may be determined by retrieving the current resource utilization from a group database that stores up-to-date resource utilization information for multiple groups. The latter may also be determined by retrieving the forecasted resource allocation from the same or different database. The latter is a static value while the former is a dynamic value that may be constantly changing. The forecasted resource utilization is a projected resource utilization for a particular time, in a resource utilization time period (e.g., a day), that corresponds to the same time as the current resource utilization. A forecasted resource utilization pacing curve represents different resource utilization points that are increasing throughout a resource utilization time period and is used to ensure that not all the resources of a group are utilized at the beginning of that time period, such as the first few hours of the day.

If the current resource utilization is significantly higher than the forecasted resource utilization at that time, then the online controller may adjust the TRM upward, so that the corresponding group may be removed from more content item selection events and not over-utilize its resources. The greater the difference between the two values, the larger the TRM adjustment. Conversely, if the current resource utilization is significantly lower than the forecasted resource utilization, then the online controller may adjust the TRM downward, so that the corresponding group may participate in more content item selection events.

In an embodiment, the online controller takes into account past TRM adjustments for a content delivery group in determining whether to further adjust the TRM for the group. For example, the online controller may take into account the change in (1) a first difference between (a) the current resource utilization of a group at time T1 and (b) the forecasted resource utilization of the group at time T1 and (2) a second difference between (a) the current resource utilization of the group at time T2 and (b) the forecasted resource utilization of the group at time T2. The online controller may also take into account the lapse in time from T1 to T2. For example, if the change is a decrease in 50% of over utilization of the resource from T1 to T2 and the time between T2 and the end of the resource utilization time period (T3) is the same as the time between T1 and T2, then no adjustment to the TRM needs to be made, even though the current resource utilization at T2 is greater than the forecasted resource utilization at T2. In a related example, given the same scenario as above except that the decrease of over utilization is 75%, then the TRM of the group is adjusted downward so that the group participates in more content item selection events, even though the current resource utilization at T2 is greater than the forecasted resource utilization at T2. The decrease in 75% of over utilization from T1 to T2 indicates that the previous increase of the TRM was too great.

### Hardware Overview

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

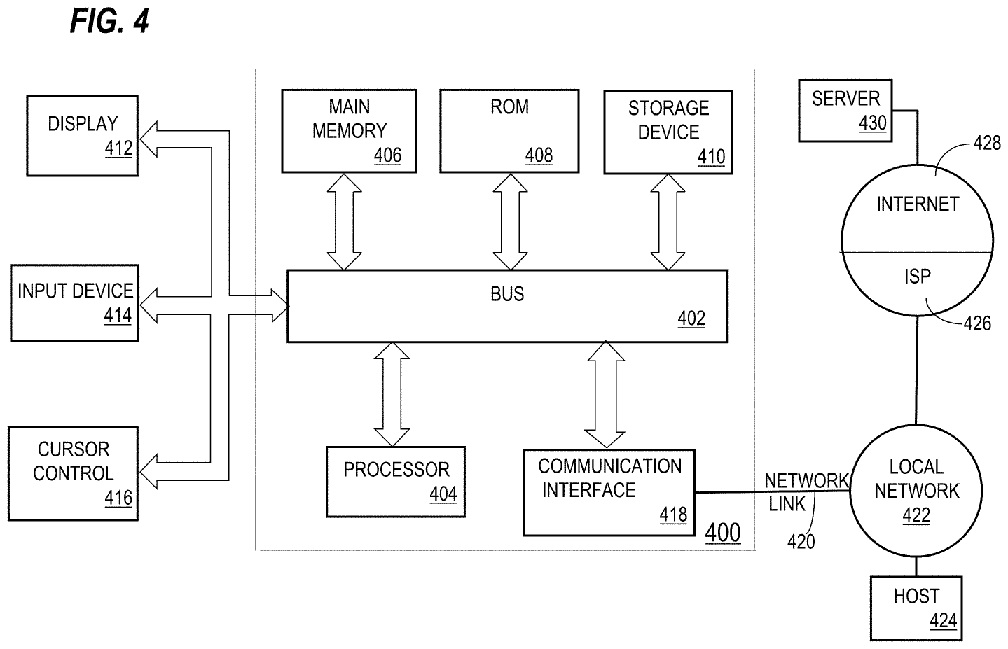

For example, FIG. 4 is a block diagram that illustrates a computer system 400 upon which an embodiment of the invention may be implemented. Computer system 400 includes a bus 402 or other communication mechanism for communicating information, and a hardware processor 404 coupled with bus 402 for processing information. Hardware processor 404 may be, for example, a general purpose microprocessor.

Computer system 400 also includes a main memory 406, such as a random access memory (RAM) or other dynamic storage device, coupled to bus 402 for storing information and instructions to be executed by processor 404. Main memory 406 also may be used for storing temporary variables or other intermediate information during execution of instructions to be executed by processor 404. Such instructions, when stored in non-transitory storage media accessible to processor 404, render computer system 400 into a special-purpose machine that is customized to perform the operations specified in the instructions.

Computer system 400 further includes a read only memory (ROM) 408 or other static storage device coupled to bus 402 for storing static information and instructions for processor 404. A storage device 410, such as a magnetic disk, optical disk, or solid-state drive is provided and coupled to bus 402 for storing information and instructions.

Computer system 400 may be coupled via bus 402 to a display 412, such as a cathode ray tube (CRT), for displaying information to a computer user. An input device 414, including alphanumeric and other keys, is coupled to bus 402 for communicating information and command selections to processor 404. Another type of user input device is cursor control 416, such as a mouse, a trackball, or cursor direction keys for communicating direction information and command selections to processor 404 and for controlling cursor movement on display 412. This input device typically has two degrees of freedom in two axes, a first axis (e.g., x) and a second axis (e.g., y), that allows the device to specify positions in a plane.

Computer system 400 may implement the techniques described herein using customized hard-wired logic, one or more ASICs or FPGAs, firmware and/or program logic which in combination with the computer system causes or programs computer system 400 to be a special-purpose machine. According to one embodiment, the techniques herein are performed by computer system 400 in response to processor 404 executing one or more sequences of one or more instructions contained in main memory 406. Such instructions may be read into main memory 406 from another storage medium, such as storage device 410. Execution of the sequences of instructions contained in main memory 406 causes processor 404 to perform the process steps described herein. In alternative embodiments, hard-wired circuitry may be used in place of or in combination with software instructions.

The term “storage media” as used herein refers to any non-transitory media that store data and/or instructions that cause a machine to operate in a specific fashion. Such storage media may comprise non-volatile media and/or volatile media. Non-volatile media includes, for example, optical disks, magnetic disks, or solid-state drives, such as storage device 410. Volatile media includes dynamic memory, such as main memory 406. Common forms of storage media include, for example, a floppy disk, a flexible disk, hard disk, solid-state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 402. Transmission media can also take the form of acoustic or light waves, such as those generated during radio-wave and infra-red data communications.

Various forms of media may be involved in carrying one or more sequences of one or more instructions to processor 404 for execution. For example, the instructions may initially be carried on a magnetic disk or solid-state drive of a remote computer. The remote computer can load the instructions into its dynamic memory and send the instructions over a telephone line using a modem. A modem local to computer system 400 can receive the data on the telephone line and use an infra-red transmitter to convert the data to an infra-red signal. An infra-red detector can receive the data carried in the infra-red signal and appropriate circuitry can place the data on bus 402. Bus 402 carries the data to main memory 406, from which processor 404 retrieves and executes the instructions. The instructions received by main memory 406 may optionally be stored on storage device 410 either before or after execution by processor 404.

Computer system 400 also includes a communication interface 418 coupled to bus 402. Communication interface 418 provides a two-way data communication coupling to a network link 420 that is connected to a local network 422. For example, communication interface 418 may be an integrated services digital network (ISDN) card, cable modem, satellite modem, or a modem to provide a data communication connection to a corresponding type of telephone line. As another example, communication interface 418 may be a local area network (LAN) card to provide a data communication connection to a compatible LAN. Wireless links may also be implemented. In any such implementation, communication interface 418 sends and receives electrical, electromagnetic or optical signals that carry digital data streams representing various types of information.

Network link 420 typically provides data communication through one or more networks to other data devices. For example, network link 420 may provide a connection through local network 422 to a host computer 424 or to data equipment operated by an Internet Service Provider (ISP) 426. ISP 426 in turn provides data communication services through the world wide packet data communication network now commonly referred to as the “Internet” 428. Local network 422 and Internet 428 both use electrical, electromagnetic or optical signals that carry digital data streams. The signals through the various networks and the signals on network link 420 and through communication interface 418, which carry the digital data to and from computer system 400, are example forms of transmission media.

Computer system 400 can send messages and receive data, including program code, through the network(s), network link 420 and communication interface 418. In the Internet example, a server 430 might transmit a requested code for an application program through Internet 428, ISP 426, local network 422 and communication interface 418.

The received code may be executed by processor 404 as it is received, and/or stored in storage device 410, or other non-volatile storage for later execution.

In the foregoing specification, embodiments of the invention have been described with reference to numerous specific details that may vary from implementation to implementation. The specification and drawings are, accordingly, to be regarded in an illustrative rather than a restrictive sense. The sole and exclusive indicator of the scope of the invention, and what is intended by the applicants to be the scope of the invention, is the literal and equivalent scope of the set of claims that issue from this application, in the specific form in which such claims issue, including any subsequent correction.

What is claimed is:

1. A method comprising:
based on a plurality of content item selection events, computing a distribution of a plurality of relevance measures for a content delivery group;
based on the distribution of the plurality of relevance measures, computing a threshold relevance measure;
receiving, over a computer network, a request for content;
in response to receiving the request, performing, by a computer system, in real-time:
identifying an identity of an entity that is associated with the request;
based on the identity of the entity, identifying a plurality of content delivery groups that includes the content delivery group;
determining a relevance measure of the content delivery group relative to the entity;
comparing the relevance measure to the threshold relevance measure;
selecting the content delivery group from among the plurality of content delivery groups only after determining that the relevance measure is above the threshold relevance measure;
wherein the method is performed by one or more computing devices.

2. The method of claim 1, further comprising:
prior to computing the distribution of relevance measures, identifying the plurality of content item selection events based on each of the plurality of content item selection events including the content delivery group.

3. The method of claim 1, wherein each relevance measure in the distribution is a predicted selection rate or a predicted view rate for the content delivery group in one of the plurality of content item selection events.

4. The method of claim 1, wherein the distribution of the plurality of relevance measures is ordered based on magnitude of the plurality of relevance measures, wherein computing the threshold relevance measure comprises:
identifying a resource allocation of the content delivery group;
for each relevance measure in a first subset of the plurality of relevance measures:
adding an event resource reduction amount, that is associated with said each relevance measure, to a total if the total is less than an amount that is based on the resource allocation;
determining the threshold relevance measure based on the total;
wherein each relevance measure in a second subset of the plurality of relevance measures is less than each relevance measure in the first subset.

5. The method of claim 4, wherein the threshold relevance measure is a second threshold relevance measure, wherein the total corresponds to a first threshold relevance measure that is greater than the second threshold relevance measure, further comprising:
determining a buffer for the first threshold relevance measure;
computing the second threshold relevance measure based on the buffer.

6. The method of claim 5, further comprising:
determining an amount of data that is used to compute the distribution of the plurality of relevance measures;
wherein determining the buffer is based on the amount of data.

7. The method of claim 1, further comprising:
determining a resource utilization rate of a second content delivery group;
based on the resource utilization rate, determining to not compute any threshold relevance measure for the second content delivery group.

8. The method of claim 1, wherein the content delivery group is a first content delivery group and the threshold relevance measure is a first threshold relevance measure, further comprising:
based on a second plurality of content item selection events, computing a second distribution of a second plurality of relevance measures for a second content delivery group that is different than the first content delivery group;
based on the second distribution of the second plurality of relevance measures, computing a second threshold relevance measure that is different than the first threshold relevance measure;
receiving, over the computer network, a second request for content;
in response to receiving the second request, performing, by the computer system, in real-time:
identifying an identity of a second entity that is associated with the second request;
based on the identity of the second entity, identifying a second plurality of content delivery groups that includes the second content delivery group;
determining a second relevance measure of the second content delivery group relative to the second entity;
comparing the second relevance measure to the second threshold relevance measure;
selecting the second content delivery group from among the second plurality of content delivery groups only after determining that the second relevance measure is above the second threshold relevance measure.

9. The method of claim 1, further comprising:
computing a throttling rate based on the relevance measure and the threshold relevance measure;
determining whether to disregard the content delivery group with respect to the request based on the throttling rate.

10. The method of claim 1, further comprising:
receiving, over the computer network, a second request for content;
in response to receiving the second request, performing, by the computer system, in real-time:
identifying an identity of a second entity that is associated with the second request;
based on the identity of the second entity, identifying a second plurality of content delivery groups that includes the content delivery group;
determining a second relevance measure of the content delivery group relative to the second entity;
determining a current resource utilization of the content delivery group;
determining a resource allocation of the content delivery group;
based on a difference between the current resource utilization and the resource allocation, adjusting the threshold relevance measure to generate an adjusted threshold relevance measure;
comparing the second relevance measure to the adjusted threshold relevance measure;
selecting the content delivery group from among the second plurality of content delivery groups only after determining that the second relevance measure is above the adjusted threshold relevance measure.

11. One or more storage media storing instructions which, when executed by one or more processors, cause:
based on a plurality of content item selection events, computing a distribution of a plurality of relevance measures for a content delivery group;
based on the distribution of the plurality of relevance measures, computing a threshold relevance measure;
receiving, over a computer network, a request for content;
in response to receiving the request, performing, by a computer system, in real-time:
identifying an identity of an entity that is associated with the request;
based on the identity of the entity, identifying a plurality of content delivery groups that includes the content delivery group;
determining a relevance measure of the content delivery group relative to the entity;
comparing the relevance measure to the threshold relevance measure;
selecting the content delivery group from among the plurality of content delivery groups only after determining that the relevance measure is above the threshold relevance measure.

12. The one or more storage media of claim 11, wherein the instructions, when executed by the one or more processors, further cause:
prior to computing the distribution of relevance measures, identifying the plurality of content item selection events based on each of the plurality of content item selection events including the content delivery group.

13. The one or more storage media of claim 11, wherein each relevance measure in the distribution is a predicted selection rate or a predicted view rate for the content delivery group in one of the plurality of content item selection events.

14. The one or more storage media of claim 11, wherein the distribution of the plurality of relevance measures is ordered based on magnitude of the plurality of relevance measures, wherein computing the threshold relevance measure comprises:
identifying a resource allocation of the content delivery group;
for each relevance measure in a first subset of the plurality of relevance measures:
adding an event resource reduction amount, that is associated with said each relevance measure, to a total if the total is less than an amount that is based on the resource allocation;
determining the threshold relevance measure based on the total;
wherein each relevance measure in a second subset of the plurality of relevance measures is less than each relevance measure in the first subset.

15. The one or more storage media of claim 14, wherein the threshold relevance measure is a second threshold relevance measure, wherein the total corresponds to a first threshold relevance measure that is greater than the second threshold relevance measure, wherein the instructions, when executed by the one or more processors, further cause:
determining a buffer for the first threshold relevance measure;
computing the second threshold relevance measure based on the buffer.

16. The one or more storage media of claim 15, wherein the instructions, when executed by the one or more processors, further cause:
determining an amount of data that is used to compute the distribution of the plurality of relevance measures;
wherein determining the buffer is based on the amount of data.

17. The one or more storage media of claim 11, wherein the instructions, when executed by the one or more processors, further cause:
determining a resource utilization rate of a second content delivery group;
based on the resource utilization rate, determining to not compute any threshold relevance measure for the second content delivery group.

18. The one or more storage media of claim 11, wherein the content delivery group is a first content delivery group and the threshold relevance measure is a first threshold relevance measure, wherein the instructions, when executed by the one or more processors, further cause:
based on a second plurality of content item selection events, computing a second distribution of a second plurality of relevance measures for a second content delivery group that is different than the first content delivery group;
based on the second distribution of the second plurality of relevance measures, computing a second threshold relevance measure that is different than the first threshold relevance measure;
receiving, over the computer network, a second request for content;
in response to receiving the second request, performing, by the computer system, in real-time:
identifying an identity of a second entity that is associated with the second request;
based on the identity of the second entity, identifying a second plurality of content delivery groups that includes the second content delivery group;
determining a second relevance measure of the second content delivery group relative to the second entity;
comparing the second relevance measure to the second threshold relevance measure;
selecting the second content delivery group from among the second plurality of content delivery groups only after determining that the second relevance measure is above the second threshold relevance measure.

19. The one or more storage media of claim 11, wherein the instructions, when executed by the one or more processors, further cause:
computing a throttling rate based on the relevance measure and the threshold relevance measure;
determining whether to disregard the content delivery group with respect to the request based on the throttling rate.

20. The one or more storage media of claim 11, wherein the instructions, when executed by the one or more processors, further cause:
receiving, over the computer network, a second request for content;
in response to receiving the second request, performing, by the computer system, in real-time:
identifying an identity of a second entity that is associated with the second request;
based on the identity of the second entity, identifying a second plurality of content delivery groups that includes the content delivery group;
determining a second relevance measure of the content delivery group relative to the second entity;
determining a current resource utilization of the content delivery group;
determining a resource allocation of the content delivery group;
based on a difference between the current resource utilization and the resource allocation, adjusting the threshold relevance measure to generate an adjusted threshold relevance measure;
comparing the second relevance measure to the adjusted threshold relevance measure;
selecting the content delivery group from among the second plurality of content delivery groups only after determining that the second relevance measure is above the adjusted threshold relevance measure.
